(19) United States
(12) Patent Application Publication
(10) Pub. No.: US 2025/0383368 A1
(43) Pub. Date: Dec. 18, 2025

(54) Method for Correcting Measurement Signals

(71) Applicant: Robert Bosch GmbH, Stuttgart (DE)

(72) Inventor: Stefan Kuntz, Flein (DE)

(21) Appl. No.: 19/231,744

(22) Filed: Jun. 9, 2025

(30) Foreign Application Priority Data
Jun. 14, 2024 (DE) 10 2024 205 493.3

(51) Int. Cl. G01P 21/02; G01P 3/46

(52) U.S. Cl. CPC G01P 21/02; G01P 3/46

(57) ABSTRACT

A method is for correcting measurement signals which are provided by at least one sensor unit. Two processed measurement signals are generated based on at least two currently provided measurement signals, from which two corrected measurement signals are generated using angle-independent arithmetic operations and at least one correction coefficient, from which a corrected angle is calculated and output. A plurality of at least two measurement signals is provided in advance in order to determine the at least one correction coefficient, from which two conditioned measurement signals are generated. A corresponding angular error is calculated on the basis of the two conditioned measurement signals and a reference angle, which is subjected to a discrete Fourier transformation. The at least one correction coefficient is determined and stored.

This application claims priority under 35 U.S.C. § 119 to patent application no. DE 10 2024 205 493.3, filed on Jun. 14, 2024 in Germany, the disclosure of which is incorporated herein by reference in its entirety.

The disclosure relates to a method for correcting measurement signals. The measurement signals may, for example, represent a rotary motion of a body detected by a sensor array or a current angular position of the moving body. An object of the disclosure is also a sensor array which is designed to carry out such a method.

### BACKGROUND

Sensor arrays are known from prior art which are used as rotary motion sensors to detect a rotary motion of a moving body or as linear displacement sensors to detect a linear motion of the moving body. Here, the current angular position of the moving body in the rotary motion or the current position of the moving body in the linear motion is not directly measured, but rather encoded in two orthogonal signals, which are commonly referred to as the sine channel and cosine channel and form a vector in the complex plane. The actual angular position of the moving body or the current position of the moving body is then calculated using the arctangent function, wherein Cartesian coordinates may essentially be converted into a polar angle. Sine signals and/or cosine signals provided by the sensor arrays may be faulty and may, for example, have an offset, an amplitude mismatch, an orthogonality error, non-linearities, etc. These errors may be corrected, for example, by an analog evaluation and control unit or digitally by a corresponding evaluation program. In order to minimize the angular error, the corresponding correction coefficients should be calculated or determined as accurately as possible. For example, it is known to calculate the correction coefficients using a Fourier transform of the sine signals and/or cosine signals provided by the sensors. As the current angular position or the current position is calculated and not measured directly, a distinction is made between a signal range and an angular range. Here, harmonic disturbances with a certain order in the signal range may also lead to harmonics in the angular range, but in a different order. The cause of this type of error depends on the measuring principle and is most often caused by manufacturing tolerances and imperfections in the sensor design, for example, non-ideal magnetization and flux distribution in magnetic sensors.

DE 102 60 862 A1 discloses a method and a circuit array for correcting an angle and/or distance-measuring sensor array in which sine and cosine measurement signals are evaluated. The measurement signals are obtained by scanning a moving measurement object. The angular errors or phase errors of the measurement signals are corrected by deriving constants for estimating and correcting the angular error or phase error and/or the amplitude of the measurement signals from a plurality of measurement signals.

DE 10 2004 029 815 A1 discloses a method and an array for correcting an angle- and/or distance-measuring sensor array in which sine and cosine measurement signals obtained by scanning a moving measurement object are evaluated. To correct the angular errors and/or phase errors of the measurement signals, the method consists of an adjustment procedure and a subsequent correction procedure. Correction parameters are provided in the adjustment procedure and a corrected pair of measured values is ascertained from each pair of measured values in the correction procedure.

### SUMMARY

The method for correcting measurement signals as described herein has the advantage that correction coefficients may be calculated in such a way that the angular error is reduced, preferably minimized, after the correction. Embodiments of the method may also be used for “difficult” measurement signals in which angular errors arise from harmonics of sine signals and/or cosine signals. The correction coefficients calculated using conventional methods are distorted by such harmonics, such that an achievable minimum of the angular error cannot be achieved.

Embodiments of the disclosure enable a calculation or determination of correction coefficients by a discrete Fourier transform of the angular error, which enable a compensation of electrical harmonic oscillations of first and/or second order in the angular error, even if these are not or not exclusively caused by offset, amplitude mismatch or orthogonality error, but, for example, by second or third electrical harmonic oscillations or harmonics of the encoder signals or sine signals and/or cosine signals. Here, the measurement signals or encoder signals may also be provided by multiphase systems with more than two measurement signals or encoder signals, which may be transformed into the complex plane after appropriate transformation (e.g., Clarke transform). For a periodicity that is greater than the value “1”, a distinction is made between a mechanical and an electrical angle, which deviates from the mechanical angle by the factor of the periodicity.

Embodiments of the disclosure provide a method for correcting measurement signals. Here, at least two measurement signals are provided by at least one sensor unit. Based on the at least two measurement signals currently provided, two conditioned measurement signals are generated, from which two corrected measurement signals are generated using angle-independent calculation operations and at least one correction coefficient, from which a corrected angle is calculated and output. To determine the at least one correction coefficient, a plurality of at least two measurement signals is provided in advance. Two conditioned measurement signals are generated on the basis of at least two measurement signals provided in advance. Based on the two conditioned measurement signals and a reference angle, a corresponding angular error is calculated, which is subjected to a discrete Fourier transform. Based on the coefficients of the discrete Fourier transform, at least one correction coefficient is determined and stored. Here, the at least one correction coefficient is determined in such a way that a remaining angular error in the corrected angle is smaller than an angular error in an angle based on the two conditioned measurement signals.

In addition, a sensor array is proposed which comprises at least one sensor unit and at least one evaluation and control unit and is designed to carry out such a method.

Embodiments of the disclosure introduce a first and second order electrical harmonic oscillation into the angular error, which counteract and cancel the corresponding harmonic oscillation present in the angular error. The amplitude and phase of the generated harmonic oscillations may be controlled by selecting the appropriate correction values for offset, amplitude mismatch, and orthogonality. It is particularly advantageous that the calculated correction values may be applied independently of the angle, which, in contrast to known harmonic compensation methods, avoids a computationally complex evaluation of trigonometric functions at the time of correction. By calculating the correction coefficients from a discrete Fourier transform of the angular error, a good quality, i.e., a low residual error, of the correction for the harmonic oscillations of the first and second orders of the angular error may still be achieved, as is possible with a complex harmonic compensation. The angle-independent application here means that the calculation operations when applying the correction values are independent of, for example, the corrected angle or the angle based on the two conditioned measurement signals. However, the use of trigonometric angle functions for correction is of course possible. An angle-dependent correction, for example, a harmonic correction, may also be carried out in addition, for example, before or after or in parallel to the angle-independent method described.

In the present case, an evaluation and control unit may be understood as an electrical assembly or electrical circuit or an electrical device, such as a control unit, which conditions or processes or evaluates the sensor signals provided. For example, the evaluation and control unit may comprise an ASIC assembly (ASIC: application-specific integrated circuit) or a microcontroller. The evaluation and control unit may comprise at least one interface, which may be implemented as hardware and/or software. When implemented as hardware, the interfaces may be part of the ASIC assembly, for example. However, it is also possible that the interfaces are dedicated integrated circuits or consist at least partly of discrete components. When implemented as software, the interfaces may be software modules present, for example, on a microcontroller alongside other software modules. A computer program product comprising program code stored on a machine-readable medium such as a semiconductor memory, a hard disk memory or an optical memory and used to perform the evaluation and to determine the at least one correction coefficient when the program is executed by the evaluation and control unit is also advantageous.

In the present case, a sensor unit is understood to be a structural unit which comprises at least one sensor element which directly or indirectly provides a physical variable or a change in a physical variable and preferably converts it into an electrical sensor signal. For example, magnetic and/or inductive sensor elements may be used.

The measures and further developments listed in the dependent claims enable advantageous improvements of the method for correcting measurement signals specified in the independent patent claim.

It is particularly advantageous that a transform and/or filtering of the at least two previously provided measurement signals and/or the at least two currently provided measurement signals may be carried out when conditioning the plurality of at least two previously provided measurement signals and/or the at least two currently provided measurement signals. For example, a first conditioned measurement signal from at least two previously provided measurement signals and a first conditioned measurement signal from at least two currently provided measurement signals may each be based on a periodic sine function with a predefined period and assigned to a sine channel. A second conditioned measurement signal from at least two previously provided measurement signals and a second conditioned measurement signal from at least two currently provided measurement signals may each be based on a periodic cosine function with the specified period and assigned to a cosine channel. Such a transform may, for example, also include a “rudimentary” compensation of a known offset of the measurement signals, especially if this is determined by the design. The design-related offset may be caused, for example, by the offset of an analog-to-digital conversion, especially in non-differential signal transmission.

In an advantageous embodiment of the method, the discrete Fourier transform may be performed in a cumulative sum of the individual angular errors calculated from the two conditioned measurement signals, which are based on the plurality of at least two measurement signals provided in advance. This has the advantage that a small amount of memory is required for the cumulative sum. Alternatively, the discrete Fourier transform may be applied to the totality of the respective angular errors calculated from the two conditioned measurement signals, which are based on the plurality of at least two measurement signals provided in advance. This means that all angular errors are first calculated for the majority of at least two provided and conditioned measurement signals and then the discrete Fourier transform is carried out.

In a further advantageous embodiment of the method, a first coefficient of the discrete Fourier transform may be based on a fundamental oscillation. A second coefficient of the discrete Fourier transform may be based on a harmonic oscillation with the order “p”. A third coefficient of the discrete Fourier transform may be based on a harmonic oscillation with the order “2p”. Here, the value “p” corresponds to the period of the first and second conditioned measurement signal.

In a further advantageous embodiment of the method, a first correction value may be calculated as the mean value of the angular errors of the plurality of at least two measurement signals provided in advance, which corresponds to a real part of the first coefficient of the discrete Fourier transform.

In a further advantageous embodiment of the method, a second correction value and a third correction value may be ascertained based on the second coefficient of the discrete Fourier transform, which are suitable for compensating a portion of the angular error based on a harmonic oscillation with the order “p”. Here, the second correction value may correspond to the calculated or estimated signal offset of the sine channel. The third correction value may correspond to the calculated or estimated signal offset of the cosine channel. Here, the second correction value may additionally be scaled with a first scaling factor, which is based on an amplitude ascertained for the sine channel, and the third correction value may additionally be scaled with a second scaling factor, which is based on an amplitude ascertained for the cosine channel.

In a further advantageous embodiment of the method, a fourth correction value and a fifth correction value may be ascertained based on the third coefficient of the discrete Fourier transform, which are suitable for compensating a first portion of the angular error based on a harmonic oscillation with the order “2p”. The first portion may, for example, correspond to an imaginary part of order “2p” of the Fourier-transformed angular error. Here, the fourth correction value may correspond to an equivalent relative amplitude of the sine channel. The fifth correction value may correspond to an equivalent relative amplitude of the cosine channel. The fourth and fifth correction values may also be combined into a common correction value, which represents the ratio of the two correction values. In addition, a sixth correction value may be ascertained based on the third coefficient of the discrete Fourier transform, which is suitable for compensating a second portion of the angular error based on a harmonic oscillation with the order “2p”. The second portion may, for example, correspond to a real part of order “2p” of the Fourier-transformed angular error. The sixth correction value may represent a calculated orthogonality error.

In a particularly advantageous embodiment of the method, the second correction value and the third correction value may be taken into account when calculating the fourth correction value and/or the fifth correction value and/or the sixth correction value. In particular, this allows portions of the angular error caused by second-order interference of the signal offset to be compensated for in the calculations of the fourth, fifth and sixth correction values, thus further improving the reduction of the angular error. This may be particularly advantageous if the effects of higher-order harmonic oscillations are significant in the case of a large offset and would lead to imperfect compensation of the second harmonic oscillation. As there is no information about the absolute signal amplitudes in the angular error, the second correction value and the third correction value each refer to the offset of a signal with unit amplitude. For use in correcting the conditioned measurement signals, these may be scaled with the amplitude of the sine channel or the cosine channel. For the same reason, only the fourth correction value may be calculated or estimated, while the cosine channel may be arbitrarily selected as a reference and the value “1” may be assigned to the fifth correction value. The scaling factors required for scaling with the amplitude of the sine channel or the cosine channel may, for example, be estimated from a discrete Fourier transform of the sine or cosine signals themselves. Alternatively, the signal amplitude may be estimated, for example, from an average value of a calculated vector length, which is based on a vector calculated from the sine signal of the sine channel and the cosine signals.

In a further advantageous embodiment of the method, the first corrected measurement signal may be generated based on the conditioned first measurement signal, the conditioned second measurement signal, the second correction value, the third correction value, the fourth correction value, the fifth correction value, and the sixth correction value. The second corrected measurement signal may be generated based on the conditioned second measurement signal, the third correction value, and the fifth correction value.

Exemplary embodiments of the disclosure are shown in the drawings and explained in more detail in the following description. In the drawings, identical reference numerals refer to components or elements performing identical or similar functions.

### BRIEF DESCRIPTION OF THE DRAWINGS

FIG. 1 shows a schematic flow diagram of an exemplary embodiment of a method according to the disclosure for correcting measurement signals.

FIG. 2 shows a schematic representation of an exemplary embodiment of a sensor array according to the disclosure when determining correction values during the execution of the method according to the disclosure from FIG. 1.

FIG. 3 shows a schematic representation of the sensor array according to the disclosure when correcting measurement signals during the execution of the method according to the disclosure from FIG. 1.

### DETAILED DESCRIPTION

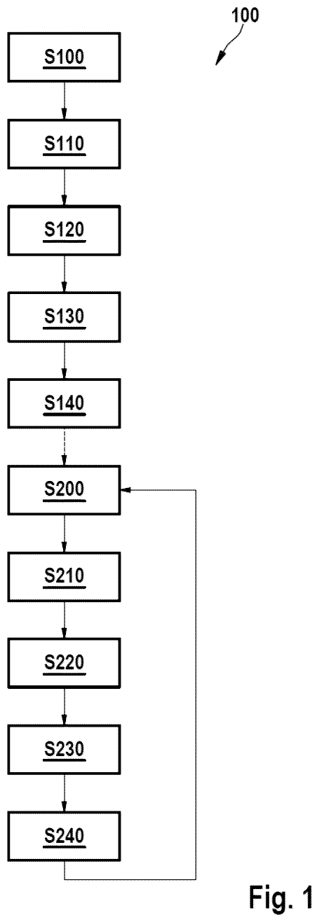

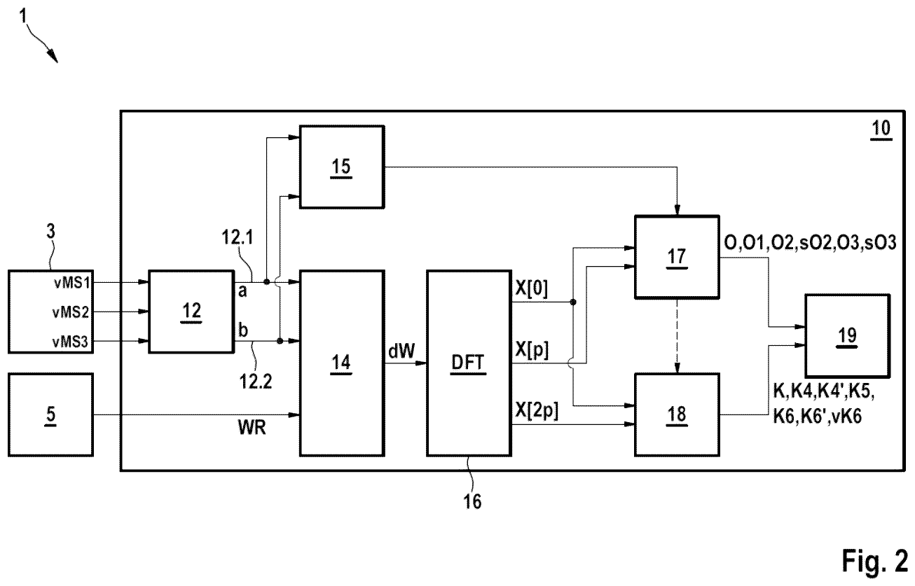

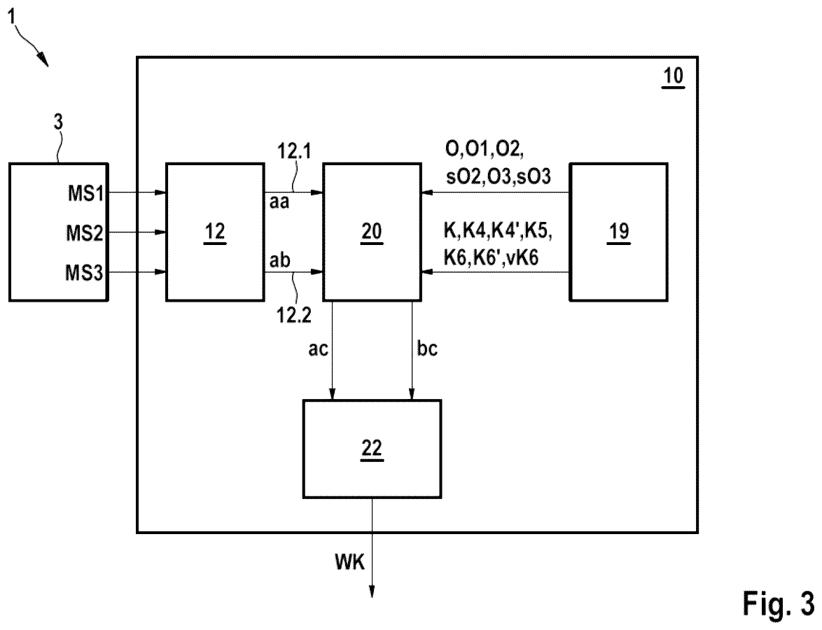

As is evident from FIG. 1, FIG. 2, and FIG. 3, the exemplary embodiment shown of a method 100 according to the disclosure for correcting measurement signals MS1, MS2, MS3 comprises a step S200 in which at least two measurement signals MS1, MS2, MS3 are provided by at least one sensor unit 3. Based on the at least two currently provided measurement signals MS1, MS2, MS3, two conditioned measurement signals a1, b1 are generated in step S210, from which two corrected measurement signals ac, bc are generated in step S220 using angle-independent arithmetic operations and at least one correction coefficient O, K. In step S230, a corrected angle WK is calculated from the two corrected measurement signals ac, bc, which is output in step S240. The process then returns to step S200.

To determine the at least one correction coefficient O, K, a plurality N of at least two measurement signals vMS1, vMS2, vMS3 is provided in advance in step S100. Based on the plurality N of at least two measurement signals vMS1, vMS2, vMS3 provided in advance, two conditioned measurement signals a, b are generated in step S110. Based on the two conditioned measurement signals a, b and a reference angle WR, a corresponding angular error dW is calculated in step S120, which is subjected to a discrete Fourier transform DFT in step S130. Based on coefficients X[0], X[p], X[2p] of the discrete Fourier transform DFT, at least one correction coefficient O, K is determined and stored in step S140. Here, the at least one correction coefficient O, K is determined in such a way that a remaining angular error dW in the corrected angle WK is smaller than an angular error dW in an angle W which is based on the two conditioned measurement signals a1, b1.

As is further evident from FIGS. 2 and 3, the exemplary embodiment shown of the sensor array 1 according to the disclosure comprises at least one sensor unit 3 and at least one evaluation and control unit 10 and is designed to carry out the method 100 according to the disclosure. In the exemplary embodiment shown, the sensor array 1 comprises only a sensor unit 3 and only an evaluation and control unit 10 having several function blocks for executing the method 100.

As is further evident from FIG. 2, the sensor unit 3 provides three measurement signals vMS1, vMS2, vMS3 for determining the at least one correction coefficient O, K for a plurality N of scans or measurements in the exemplary embodiment shown. When conditioning the plurality N of three measurement signals vMS1, vMS2, vMS3 provided in advance, a Clarke transform of the three measurement signals vMS1, vMS2, vMS3 provided in advance is carried out in a first calculation block 12 in each case into a first conditioned measurement signal a based on a periodic sine function with a predetermined period p and into a second conditioned measurement signal b based on a periodic cosine function with the predetermined period p. Here, the first conditioned measurement signal a is assigned to a sine channel 12.1, and the second conditioned measurement signal b is assigned to a cosine channel 12.2.

By considering only periodic disturbances, neglecting, for example, noise, the conditioned measurement signals a, b may each be written as a Fourier series according to equations (1) and (2).

$$a ( W ) = {A}_{0} + {A}_{p} sin ( pW + {V}_{p} ) + {\sum }_{{n = 1}_{n \neq p}}^{∞} {A}_{n} sin ( nW + Vn ) \qquad ( 1 )$$

$$b ( W ) = {B}_{0} + {B}_{p} cos ( pW + {U}_{p} ) + {\sum }_{{n = 1}_{n \neq p}}^{∞} {B}_{n} cos ( nW + Un ) \qquad ( 2 )$$

Here, A₀ is a signal offset and Aₚ is an amplitude of a fundamental wave of order p of the sine channel 12.1. B₀ is a signal offset and Bp is an amplitude of a fundamental wave of order p of the cosine channel 12.2. Vp is a phase angle of the fundamental wave of the sine channel 12.1 and Up is a phase angle of the fundamental wave of the cosine channel 12.2. Equation (3) defines an orthogonality error OF.

$${OF}_{p} = {V}_{p} - {U}_{p} \qquad ( 3 )$$

The electrical angular error dW is given by equation (4) and is calculated in a first calculation block 14 of the evaluation and control unit 10 based on the first conditioned measurement signal a of the sine channel 12.1 and the second conditioned measurement signal b of the cosine channel 12.2, taking into account a provided reference angle WR. The reference angle WR may, for example, be provided by a drive of a moving body whose angular position or position is to be determined. In addition, the evaluation and control unit 10 performs an amplitude calculation in a second calculation block 15 based on the first conditioned measurement signal a of the sine channel 12.1 and the second conditioned measurement signal b of the cosine channel 12.2. Here, for example, a vector may be calculated from the first conditioned measurement signal a of the sine channel and the second conditioned measurement signal b of the cosine channel. The signal amplitudes of the sine channel 12.1 and/or the cosine channel 12.2 may then be calculated from an average value of a corresponding vector length.

$$dW = arctan ( \frac{a ( W )}{b ( W )} ) - pW \qquad ( 4 )$$

Equation (4) is only valid for a limited range of the electrical angle W, as the quadrants are ambiguous and may be divided by zero. In practice, this problem is solved by a modified arctangent function with two arguments, known as atan2(a,b). Here, the arctan result is unpacked (“unwrapped”) to remove the influence of discontinuities.

The second calculation block 15 subjects the angular error dW to the discrete Fourier transform DFT and calculates the coefficients X[0], X[p], X[2p], which are used to determine the at least one correction coefficient O, K. The coefficients X[0], X[p], X[2p] of the discrete Fourier transform DFT are calculated from the amplitude-normalized discrete Fourier transform DFT of the angular error dW of a measurement over 360° mechanically according to equations (5) and (6).

$$X = DFT \{ dW \} \qquad ( 5 )$$

$$X [ k ] \{ \begin{matrix}\frac{1}{N} {\sum }_{j = 0}^{N - 1} {dW}_{j} & k = 0 \\ \frac{2}{N} {\sum }_{j = 0}^{N - 1} {dW}_{j} {e}^{- 2 π i \frac{jk}{N}} & k > 0\end{matrix} \qquad ( 6 )$$

Here, a real part of “X[0]” is equal to the mean value of the angular error dW. “X[k]” is equal to the amplitude of a sine curve of the k-th harmonic oscillation, provided that the angular error dW is real, where “i” is the imaginary unit. To calculate the at least one correction coefficient O, K, a first coefficient X[0] of the discrete Fourier transform DFT, which is based on a fundamental oscillation, and a second coefficient X[p] of the discrete Fourier transform DFT, which is based on a harmonic oscillation with the order “p”, and a third coefficient X[2p] of the discrete Fourier transform DFT, which is based on a harmonic oscillation with the order “2p”, are used. Here, the value “p” corresponds to the period p of the first and second conditioned measurement signals a, b.

In the exemplary embodiment shown of the method 100, the discrete Fourier transform DFT is performed in a cumulative sum of the individual angular errors dW calculated from the two conditioned measurement signals a, b, which are based on the plurality N of the three measurement signals vMS1, vMS2, vMS3 provided in advance.

In an alternative exemplary embodiment of the method 100, which is not shown, the discrete Fourier transform DFT is applied to the totality of the respective angular errors dW calculated from the two conditioned measurement signals a, b, which are based on the plurality N of the three measurement signals vMS1, vMS2, vMS3 provided in advance.

As is further evident from FIG. 2, the coefficients X[0], X[p] of the discrete Fourier transform DFT and the result of the amplitude calculation in the second calculation block 15 are provided to a third calculation block 17. The amplitude calculation in the second calculation block 15 is based here on the vector calculated from the first conditioned measurement signal a of the sine channel and the second conditioned measurement signal b of the cosine channel. According to equation (7), the third calculation block 17 calculates a first correction value O1 as the mean value of the angular error dW, which corresponds to a real part RE of the first coefficient X[0] of the discrete Fourier transform DFT. The individual angular errors dW are ascertained based on an angle W, which is determined in each case from the plurality N of the at least two measurement signals vMS1, vMS2, vMS3 provided in advance, and the reference angle WR. The first correction value O1 may be interpreted as an average angular deviation between the measured angle W and the reference angle WR, which may be caused, for example, by the installation of the sensor unit 3.

$$O 1 = Re \{ X [ 0 ] \} \qquad ( 7 )$$

Based on the second coefficient X[p] of the discrete Fourier transform DFT, the third calculation block 17 calculates a second correction value 02 according to equation (8) and a third correction value O3 according to equation (9). As there is no information about the absolute signal amplitudes in the angular error dW, the second correction value O2 and the third correction value O3 each refer to the offset of a signal with unit amplitude. For use in correcting the conditioned measurement signals a1, b1, a scaled second correction value sO2 in the exemplary embodiment shown is additionally scaled according to equation 8A with a first scaling factor S1, which is based on an amplitude ascertained in the second calculation block 15 for the sine channel 12.1. The scaled third correction value sO3 is additionally scaled in the illustrated exemplary embodiment according to equation 9A with a second scaling factor S2, which is based on an amplitude ascertained in the second calculation block 15 for the cosine channel 12.2.

$$O 2 = Re \{ X [ p ] {e}^{- i ( O 1 )} \} \qquad ( 8 )$$

$$O 3 = Im \{ X [ p ] {e}^{- i ( O 1 )} \} \qquad ( 9 )$$

$$sO 2 = ( Re \{ X [ p ] {e}^{- i ( O 1 )} \} ) * S 1 \qquad ( 8 A )$$

$$sO 3 = ( Im \{ X [ p ] {e}^{- i ( O 1 )} \} ) * S 2 \qquad ( 9 A ) )$$

The second correction value O2 or the scaled second correction value sO2 and the third correction value O3 or the scaled third correction value sO3 are suitable for compensating a portion of the angular error dW based on a harmonic oscillation with the order “p”.

As is further evident from FIG. 2, the coefficients X[0], X[2p] of the discrete Fourier transform DFT are provided to a fourth calculation block 18. In the exemplary embodiment shown, the fourth calculation block 18 calculates a fourth correction value K4′ according to equation (10) based on the third coefficient X[2p] of the discrete Fourier transform DFT. In the exemplary embodiment shown, the fourth calculation block 18 also takes into account the second correction value O2 and the third correction value O3 from the third calculation block 17 when calculating the improved fourth correction value K4 according to equation (10A). In addition, the fourth calculation block 18 sets a fifth correction value K5 to the value “1”.

$$K {4}^{′} = \frac{1 - Im \{ X [ 2 p ] {e}^{- i 2 ( O 1 )} \}}{1 + Im \{ X [ 2 p ] {e}^{- i 2 ( O 1 )} \}} \qquad ( 10 )$$

$$K 4 = \frac{1 - ( Im \{ X [ 2 p ] {e}^{- i 2 ( O 1 )} \} + \frac{1}{2} ( {( O 3 )}^{2} - {( O 2 )}^{2} ) )}{1 + Im \{ X [ 2 p ] {e}^{- i 2 ( O 1 )} \} + \frac{1}{2} ( {( O 3 )}^{2} - {( O 2 )}^{2} )} \qquad ( 10 A )$$

The fourth correction value K4′ or the improved fourth correction value K4 and the fifth correction value K5 are suitable for compensating a first portion of the angular error dW based on a harmonic oscillation with the order “2p”, which corresponds to an imaginary part of the order “2p” of the Fourier-transformed angular error dW. The fourth and fifth correction values K4, K5 may also be combined into a common correction value KG, which represents the ratio of the two correction values (K4/K5).

As is further evident from FIG. 2, the fourth calculation block 18 calculates a sixth correction value K6′ according to equation 11 based on the third coefficient X[2p] of the discrete Fourier transform DFT. In the exemplary embodiment shown, the fourth calculation block 18 also takes into account the second correction value O2 and the third correction value O3 from the third calculation block 17 when calculating the improved sixth correction value K6 according to equation (11A).

$$K {6}^{′} = 2 Re \{ X [ 2 p ] {e}^{- i 2 ( O 1 )} \} \qquad ( 11 )$$

$$K 6 = 2 ( Re \{ X [ 2 p ] {e}^{- i 2 ( O 1 )} \} + ( O 2 ) ( O 3 ) ) \qquad ( 11 A )$$

$$vK 6 = K 6 - ( \frac{1}{12} {( K 6 )}^{3} ) \qquad ( 11 B )$$

The sixth correction value K6′ or the improved sixth correction value K6 is suitable for compensating a second portion of the angular error dW based on a harmonic oscillation of order 2p, which corresponds to a real part of order “2p” of the Fourier-transformed angular error dW. In addition, when calculating a further improved sixth correction value vK6 according to equation (11B), a third power of the improved sixth correction value K6 may be used. This allows a lower residual error to be achieved in the case of large orthogonality errors.

When calculating the second, third, fourth, improved fourth, fifth, sixth, improved sixth and further improved sixth correction values O2, sO2, O3, sO3, K4′, K4, K5, K6′, K6 and vK6, the first correction value O1 is used in each case to compensate for the influence of the mean angular deviation. Alternatively, this may also be done by already compensating the calculation of the angular error dW with a correction value similar to the first correction value O1, which is determined, for example, by an additional prior calculation of the angular error dW.

As may also be seen in FIG. 2, the correction values O1, O2, sO2, O3, sO3, K4, K4′, K5, K6, K6′, vK6 are stored in a memory unit 19.

As is further evident FIG. 3, the sensor unit 3 provides three current measurement signals MS1, MS2, MS3 based on a current scan or measurement in the exemplary embodiment shown. When conditioning the three current measurement signals MS1, MS2, MS3, the first calculation block 12 performs the Clarke transform of the three currently provided measurement signals MS1, MS2, MS3 and transforms them into a first conditioned measurement signal a1 based on a periodic sine function with a predetermined period p and into a second conditioned measurement signal b1 based on a periodic cosine function with the predetermined period p. Here, the first conditioned measurement signal a1 is assigned to the sine channel 12.1 and the second conditioned measurement signal b1 is assigned to the cosine channel 12.2.

As is further evident from FIG. 3, in the exemplary embodiment shown, a correction block 20 generates the first corrected measurement signal ac according to equation (12) based on the conditioned first measurement signal a1, the conditioned second measurement signal b1, the scaled second correction value sO2, the scaled third correction value sO3, the fourth correction value K4, the fifth correction value K5, and the sixth correction value K6. Here, the correction values sO2, sO3, K4, K5 and K6 are provided by the memory unit 19.

$$ac = \frac{( a 1 - sO 2 ) - ( b 1 - sO 3 ) \frac{K 4}{K 5} sin ( K 6 )}{K 4 cos ( K 6 )} \qquad ( 12 )$$

Based on the conditioned second current measurement signal b1, the scaled third correction value sO3 and the fifth correction value K5, the correction block 20 generates the second corrected measurement signal bc according to equation (13). Here, the correction values sO3 and K5 are provided by the memory unit 19.

$$bc = \frac{b1 - sO 3}{K 5} \qquad ( 13 )$$

Of course, the constant portions shown in equation (12) may also be precalculated to improve the calculation speed and stored in the memory unit 19 in addition to or instead of the correction values. This allows, for example, trigonometric operations such as “sin(K6)” or “cos(K6)” to be avoided at runtime. Furthermore, the corrected second signal bc may advantageously be calculated first according to equation (13) and then used directly in equation (12) to calculate the first corrected measurement signal ac without recalculating the portions ((b1−sO3)/K5) shown in equation (12).

In the output block 22, the corrected angle WK is calculated from the corrected measurement signals ac, bc and output. Here, a remaining angular error dW in the corrected angle WK is smaller than an angular error dW in an angle based on the two conditioned but uncorrected measurement signals al, b1. In addition, an angular offset in the corrected angle WK may be compensated for with the first correction value O1. Furthermore, an angular offset influenced by the orthogonality may also be compensated for with the sixth, the improved sixth, and the further improved correction value K6′, K6, vK6.

What is claimed is:

1. A method for correcting measurement signals, comprising:
providing at least two currently-provided measurement signals using at least one sensor unit;
generating two conditioned measurement signals based on the at least two currently-provided measurement signals, from which two corrected measurement signals are generated using angle-independent arithmetic operations and at least one correction coefficient, from which a corrected angle is calculated and output;
providing at least two previously-provided measurement signals in advance to determine the at least one correction coefficient;
generating two conditioned advance measurement signals based on the at least two previously-provided measurement signals; and
calculating a corresponding angular error based on the two conditioned advance measurement signals and a reference angle, which is subjected to a discrete Fourier transform (“DFT”),
wherein based on coefficients of the DFT, the at least one correction coefficient is determined and stored, and
wherein the at least one correction coefficient is determined such that a remaining angular error in the corrected angle is smaller than a further angular error in an angle which is based on the two conditioned measurement signals.

2. The method according to claim 1, wherein during conditioning of the at least two previously-provided measurement signals and/or of the at least two currently-provided measurement signals, a transform and/or a filtering of the at least two previously-provided measurement signals and/or of the at least two currently-provided measurement signals is carried out in each case.

3. The method according to claim 1, wherein:
a first previously-provided conditioned measurement signal of the at least two previously-provided measurement signals and a first currently-provided conditioned measurement signal of the at least two currently-provided measurement signals are each based on a periodic sine function with a predetermined period and are assigned to a sine channel, and
a second previously-provided conditioned measurement signal of the at least two previously-provided measurement signals and a second currently-provided conditioned measurement signal of at least two currently-provided measurement signals are each based on a periodic cosine function with the predetermined period and are assigned to a cosine channel.

4. The method according to claim 3, wherein the DFT is performed in a cumulative sum of individual angular errors calculated from the first previously-provided conditioned measurement signal and the second previously-provided conditioned measurement signal, which are based on the at least two previously-provided measurement signals.

5. The method according to claim 3, wherein the DFT is applied to a totality of respective angular errors calculated from the first previously-provided conditioned measurement signal and the second previously-provided conditioned measurement signal, which are based on the at least two previously-provided measurement signals.

6. The method according to claim 5, wherein:
a first coefficient of the DFT is based on a fundamental oscillation,
a second coefficient of the DFT is based on a harmonic oscillation with an order p,
a third coefficient of the DFT is based on a harmonic oscillation with an order 2p, and
a value “p” corresponds to a period the first previously-provided conditioned measurement signal and the second previously-provided conditioned measurement signal.

7. The method according to claim 6, wherein a first correction value is calculated as a mean value of a totality of respective angular errors calculated from the at least two previously-provided measurement signals, which corresponds to a real part of the first coefficient of the DFT.

8. The method according to claim 7, wherein based on the second coefficient of the DFT, a second correction value and a third correction value are ascertained, which are suitable for compensating a portion of the totality of respective angular errors based on a harmonic oscillation with the order p.

9. The method according to claim 8, wherein:
the second correction value is additionally scaled with a first scaling factor, which is based on an amplitude ascertained for the sine channel, and
the third correction value is additionally scaled with a second scaling factor, which is based on an amplitude ascertained for the cosine channel.

10. The method according to claim 8, wherein based on the third coefficient of the DFT, a fourth correction value and a fifth correction value are ascertained, which are suitable for compensating a first portion of the totality of respective angular error based on a harmonic oscillation with the order 2p.

11. The method according to claim 10, wherein a sixth correction value is ascertained based on the third coefficient of the DFT for compensating a second portion of the totality of respective angular error based on a harmonic oscillation with the order 2p.

12. The method according to claim 11, wherein the second correction value and the third correction value are used to calculate the fourth correction value, the fifth correction value, and/or the sixth correction value.

13. The method according to claim 10, wherein the cosine channel is selected as the reference angle and a value “1” is assigned to the fifth correction value.

14. The method according to claim 11, wherein a first corrected measurement signal of the two corrected measurement signals is generated based on the first previously-provided conditioned measurement signal, the second previously-provided conditioned measurement signal, the second correction value, the third correction value, the fourth correction value, the fifth correction value, and the sixth correction value.

15. The method according to claim 14, wherein a second corrected measurement signal of the two corrected measurement signals is generated based on the second previously-provided conditioned measurement signal, the third correction value, and the fifth correction value.

16. A sensor array, comprising:
at least one sensor unit; and
at least one evaluation and control unit operably connected to the at least one sensor unit and configured to carry out the method according to claim 1.
